(19) United States
(12) Patent Application Publication
(10) Pub. No.: US 2004/0066550 A1
(43) Pub. Date: Apr. 8, 2004

(54) Optical pulse reshaping system

(76) Inventor: Paul R. Jay, Stittsville (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/261,497

(22) Filed: Oct. 2, 2002

(51) Int. Cl. H01S 3/00; H04B 10/12

(52) U.S. Cl. 359/337.1; 359/334

(57) ABSTRACT

An optical edge regeneration system is disclosed herein. The edge regeneration system employs selective amplification in the optical domain to amplify portions of a pulse train that correspond to peaks in the train, while allowing the non-peak portions of the pulse train to pass through without amplification.

### FIELD OF THE INVENTION

The present invention relates generally to reshaping the pulses in a transmitted signal. More particularly, the present invention relates to regenerating the edges of a pulse train in an all optical environment by reshaping the pulses through selective amplification.

### BACKGROUND OF THE INVENTION

Optical networks have gained popular acceptance in the telecommunications field as a result of their relatively high signal-to-noise (S/N) ratios. The high S/N ratios allow high data rate communications between two nodes, with relatively low bit-error-rate levels. Each optical fiber can host a plurality of distinct data channels which, if properly configured, will not interfere with each other. However, despite the high S/N ratio, the transmitted signal is eventually degraded. Many uses of optical networks centre around the transmission of pulse coded binary data. Binary digits are typically represented by a sequence of square wave pulses. Despite the high S/N ratio of optical fibers, as a pulse is transmitted through the optical fiber, it is degraded. Attenuation and noise result in the loss of definition in the edges of the pulse and diminished pulse amplitude. After having been transmitted large distances, the pulse can be degraded to such an extent that the information it represents cannot be recovered.

To prevent the loss of the information sequence encoded in a pulse train the following degradations must be compensated for: absorption of transmitted energy resulting in power loss, noise which can make logically low values appear logically high, and dispersion which results in the spreading of a transmitted pulse. All of these three factors impair the ability of a receiver to distinguish logical high and low values, as will be well understood by one skilled in the art.

To overcome absorption, amplifiers can be added to the channel to amplify the signal strength. These amplifiers typically include both doped fiber amplifiers, semiconductor optical amplifiers and Raman amplifiers. The operation of these amplifiers is known to those of skill in the art. Such Raman amplifiers magnify the amplitude of a received signal to compensate for power loss. To overcome the problems associated with both dispersion and noise, which both impair the ability of a receiver to determine where pulses start and stop, repeaters are introduced into optical networks. As with non-optical networks, the function of a repeater is to receive a partially degraded signal and to then transmit a reconstructed version of the received signal.

In conventional optical networks, opto-electrical repeaters are used to provide edge regeneration of the signal, and to compensate for edge related noise. Conventional repeaters in an optical network demultiplex a Dense Wave Division Multiplexed (DWDM) signal in the optical domain to a series of Time Division Multiplexed (TDM) electrical domain signals. The series of TDM signals are then TDM demultiplexed to obtain copies of all the transmitted data sequences. These sequences are decoded in the electrical domain, and are subject to error checking and correction, before the repeater re-encodes the electrical domain signals, and multiplexes them using a TDM multiplexer. The series of TDM signals are then optically DWDM multiplexed prior to re-transmission. This process requires expensive equipment and introduces a delay into the optical communications channel.

To reduce the cost of opto-electrical repeaters and the associated delay introduced by them, repeaters are employed in conjunction with amplifiers, so that the time consuming and costly process of edge regeneration occurs only when a signal is so attenuated that further amplification and transmission would impair signal integrity. The cost and time delay could be mitigated by an all optical repeater that could provide edge regeneration to a degraded signal.

It is, therefore, desirable to provide an optical edge regeneration system that does not require electrically decoding a multiplexed optical signal.

### SUMMARY OF THE INVENTION

It is an object of the present invention to obviate or mitigate at least one disadvantage of previous optical network edge regeneration systems.

In a first aspect of the present invention, there is provided an optical edge reshaping controller. The controller is for controlling the actuation of an optical amplifier to selectively amplify an input signal by determining a priming energy that is sufficient to amplify peaks in a pulse train but is insufficient to amplify the non peak portions of the pulse train. In a presently preferred embodiment, the controller is for controlling a pump laser, to provide priming energy to a Raman amplifier, to amplify a pulse train, to reshape the edges of pulses in the pulse train. The controller comprises a regeneration controller for controlling the pump laser by determining the priming energy sufficient to amplify peak regions of the pulse train exceeding a threshold, and insufficient to amplify non-peak regions of the pulse train not exceeding the threshold.

In an embodiment of the first aspect of the present invention the regeneration controller includes means for controlling the pump laser to generate a square wave priming signal for pumping the Raman amplifier.

In another embodiment of the first aspect of the present invention, the regeneration controller includes a clock recovery unit for determining the frequency, and optionally the phase, of the pulse train, and for controlling the pump laser to generate a square wave priming signal having the same frequency as the pulse train. In a further embodiment, there is provided a photodetector, for sampling the pulse train, that is operatively connected to the clock recovery unit to provide the clock recovery unit with an indication of the location of the pulses in the pulse train from which the frequency of the pulse train can be determined. Optionally, there is provided a splitter for receiving the pulse train, operatively connected to both the Raman amplifier and the photodetector, for providing both the Raman amplifier and the photodetector with the received pulse train. In another embodiment, the regeneration controller further includes a feedback control unit, operatively connected to the Raman amplifier for sampling the amplified pulse train, for synchronising the phase of the generated square wave priming signal to the phase of the pulse train.

In another embodiment of the first aspect of the present invention, the optical edge reshaper, further includes a pulse discriminator for controlling the pump laser to generate a square wave priming signal with pulses corresponding, in frequency and phase, to the pulses in the pulse train.

In yet another embodiment of the first aspect of the present invention, the regeneration controller further includes an amplitude control unit for adjusting the amplitude of the priming energy to effect gain saturation in the Raman amplifier. In various embodiments, the amplitude control unit is operatively connected to the Raman amplifier for sampling the amplified pulse train to determine the required amplitude of the priming energy to effect gain saturation in the amplification of the pulse train. In other embodiments, the amplitude control unit includes means for sampling the pulse train and determining the required amplitude of the priming energy to effect gain saturation in the amplification of the pulse train based on the amplitude of the pulses in the pulse train.

In an alternate embodiment of the present invention, the regeneration controller further includes a feedback control unit for sampling the amplified pulse train, and for adjusting the phase of the generated square wave priming signal to synchronise the phase of the generated square wave pumped laser to the phase of the pulse train. In various embodiments, the feedback control unit also includes means for adjusting the frequency of the generated square wave priming signal to synchronise the frequency of the generated square wave pumped laser to the frequency of the pulse train.

In a further embodiment, the controller is for controlling an actuator to provide an actuation signal, or priming energy to a semiconductor optical amplifier (SOA) where the actuation signal is either frequency or phase synchronised with the input signal.

In a second aspect of the present invention, there is provided a method of regenerating the edge of an optical pulse in a pulse train using an optical amplifier. The method comprises three steps. The first step is to determine a priming energy level, for the optical amplifier, sufficient to amplify peak regions of the pulse train exceeding a threshold, and insufficient to amplify non-peak regions of the pulse train. The next step is to control the priming of the optical amplifier in accordance with the determined priming energy level. The following step is to feed the pulse train to the primed optical amplifier to amplify regions of the pulse train exceeding the threshold. In an embodiment of the present invention, the first step further includes determining a priming energy level, to be provided by a pump laser to a Raman amplifier; the second step further includes controlling the Raman amplifier; and the final step includes feeding the input signal to the Raman amplifier.

In an embodiment of the second aspect of the invention the step of determining includes performing a clock recovery operation on the pulse train to determine the frequency of the pulse train, and the step of controlling the Raman amplifier optionally includes generating a square wave having an amplitude equal to the determined priming energy level at the determined frequency and providing the generated square wave to the Raman amplifier. In another embodiment of the present invention, the method including the step of sampling the pulse train at an input or output of the Raman amplifier and adjusting the phase of the generated square wave to synchronise its phase to the phase of the pulse train. In a further embodiment of the present invention, there is included the step of sampling the amplified pulse train at an output of the Raman amplifier and adjusting the priming energy level to effect gain saturation in the step of amplifying.

In an alternate embodiment of the second aspect of the present invention, the step of determining includes performing a clock recovery operation on the pulse train to determine at least one of the phase and frequency of the pulse train, and the step of controlling includes controlling the actuation of a semiconductor optical amplifier by controlling an actuator to provide a square wave actuation signal having either determined frequency or phase.

In a third aspect of the present invention, there is provided an optical edge reshaper for reshaping the edges of pulses in a pulse train. The reshaper comprises an optical amplifier, an actuator and a regeneration controller. The optical amplifier is for receiving and amplifying the pulse train. The actuator is for providing priming energy or an actuation signal to the optical amplifier. The regeneration controller is for controlling the actuator by determining the priming energy sufficient to amplify peak regions of the pulse train exceeding a threshold, and insufficient to amplify non-peak regions of the pulse train not exceeding the threshold. In one embodiment of the third aspect of the present invention, the optical amplifier is a Raman amplifier and the actuator is a pump laser. In an alternate embodiment of the third aspect of the present invention, the optical amplifier is a semiconductor optical amplifier.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a system of the present invention;

FIG. 2 is an alternate system of the present invention;

FIG. 3 is a flowchart illustrating a method of the present invention;

FIG. 4 is a flowchart illustrating an alternate method of the present invention;

FIG. 5 illustrates another alternate system of the present invention; and

FIG. 6 illustrates an embodiment of the present invention.

### DETAILED DESCRIPTION

Generally, the present invention provides a method and system for optically regenerating the edges of pulses in an optically transmitted pulse train.

The purpose of a repeater in an optical network is to provide both amplification and edge regeneration through the reshaping of transmitted pulses. As signals are transmitted they are affected by noise, dispersion and absorption, which results in pulse spreading, and loss of definition in the edges of pulses. The present invention seeks to provide pulse and edge regeneration, by reshaping the pulse through selective amplification. The present invention provides both regenerated edges and an amplified magnitude to optical signals. Selective amplification is used to amplify only the peaks of pulses in a pulse train. By doing this the peaks are substantially greater in magnitude than the non-peak regions, and the transition between them is sharp enough to restore edges. Selective amplification is performed through the use of optical amplifiers with either non-linear amplification characteristics, or optical amplifiers with rapid response times that can be rapidly actuated. Raman amplifiers and SOAs are two examples of such amplifiers. Raman amplifiers are non-linear in nature, and are rapidly actuated by control of the pump laser that provides the priming energy. SOAs are linear amplifiers that can be rapidly actuated by controlling the current input that provides the priming energy or actuation signal.

In one embodiment of the present invention the non-linear nature of the Raman effect is used to amplify only those portions of an information signal, which is in the form of a pulse train, corresponding to the peaks of pulses. The non-peak portions of the received signal proceed through the system substantially without amplification. This non-uniform amplification results in a near square wave output. In one embodiment, both the noise effects near the edges of the pulses, and the uneven tops of the pulses remain, but, due to the fact that only the pulses have been amplified, the result is a pulse train with distinct edges. In a further embodiment, tuning of the Raman amplifier results in gain saturation, which restores substantially flat tops to the pulses. Because the reshaping of pulses taught below effectively provides pulse regeneration, the terms are used interchangeably.

Raman amplification is a result of Raman scattering in an optical medium. As light of a given wavelength is introduced to the medium it undergoes scattering. When a sufficient amount of energy is introduced at the given wavelength, a transmitted signal can be amplified using this Raman scattering. Below this threshold, no amplification occurs. When amplifying an information signal, Raman amplifiers are typically primed by a pump laser, which ensures that a sufficient amount of energy is present to cause Raman amplification. The Raman amplifier then provides, as output, an amplified version of the information signal. Without the priming of the Raman amplifier, the information signal will not be amplified.

A presently preferred embodiment of the present invention, as described in detail below, uses a Raman amplifier to receive a degraded pulse train. The amplifier is provided with sufficient energy from a pump laser to allow only the peaks of the pulse train to be amplified. To amplify only the peaks, the pumped laser input is tuned, so that it only provides enough power to cause Raman amplification when the priming laser input is combined with the energy of the peak of a pulse in the received pulse train. The pump laser can be at a constant energy level, or can be pulsed in phase with the pulse train such that only the regions of the pulse train that correspond to peaks have a pulse superimposed on them. The superpositioning of the peak of the pulse and the pump laser output results in a sufficient energy level to cause Raman amplification.

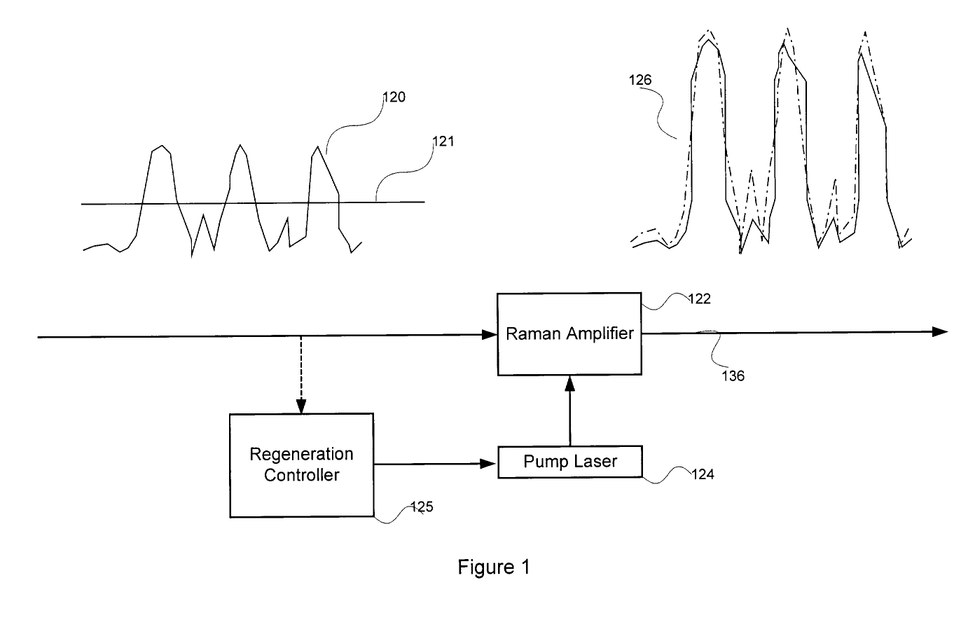

FIG. 1 illustrates an embodiment of the system of the present invention. As illustrated in FIG. 1, a degraded pulse train 120 is received by Raman amplifier 122. Raman amplifier 122 also receives the output of pump laser 124. Pump laser 124 is controlled by regeneration controller 125 to provide an appropriate priming signal to Raman amplifier 122 so that the regions of pulse train 120 having sufficient energy when combined with the priming signal (i.e. the peaks) undergo Raman amplification. The portions of the pulse train that, in combination with the priming signal, do not provide sufficient energy to cause Raman amplification do not undergo amplification. Threshold 121 indicates which portions of pulse train 120 have sufficient energy to undergo Raman amplification with the priming energy from pump laser 124. In this embodiment, because only the portions of pulse train 120 that exceed threshold 121 are amplified, there is a discontinuity in pulse train 120 at the points corresponding to the intersection on pulse train 120 and threshold 121. This discontinuity results in the restoration of vertical edges in amplified pulse train 126 at the output 136 or Raman amplifier 122. These vertical edges can be easily distinguished by a receiver. Amplified pulse train 126 can be compared to the results of a simple amplification, which is shown as an overlapping signal in dashed lines.

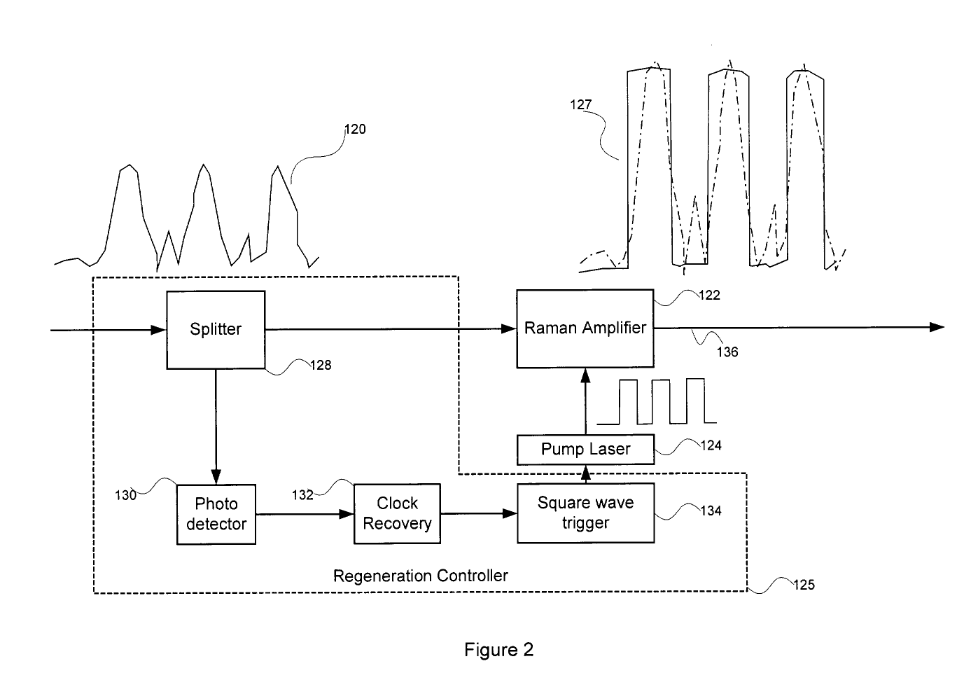

FIG. 2 illustrates an alternate embodiment of the system of the present invention. As in the system of FIG. 1, a degraded pulse train 120 is received. Prior to its arrival at Raman amplifier 122, degraded pulse train 120 is received by regeneration controller 125. In regeneration controller 125, splitter 128 serves to provide a sample of pulse train 120 to photodetector 130. Photodetector 130 is used to analyse degraded pulse train 120 and to provide an indication of the location of the peaks in pulse train 120 to clock recovery unit 132. With the indication from photodetector 130, clock recovery unit 132 determines the frequency of pulse train 120. Photodetector 130 and clock recovery unit 132 are conventional components and their operation and manufacture will be well understood by those of skill in the art. Clock recovery unit 132 determines the frequency and, in a presently preferred embodiment, the phase of pulse train 120. This information is used by trigger 134 to generate a square wave. Trigger 134 interfaces with pump laser 124, providing it with the triggering square wave so that the output of pump laser 124 is a square wave having the same frequency as pulse train 120. As in FIG. 1, pump laser 124 provides its output, which in this instance is a square wave having the same frequency as pulse train 120, to Raman amplifier 122. Raman amplifier 122, as before, amplifies only the portions of pulse train 120 having sufficient energy to cause Raman amplification after superpositioning of the priming energy from pump laser 124. Because pump laser 124 is controlled by trigger 134 to generate a square wave that when superimposed on pulse train 120 overlaps the pulses, the amplitude of the square wave pumped laser can be adjusted to ensure that all portions of the pulse train corresponding to pulses are amplified. This amplification of only the peaks results in the regeneration of square edges on the pulse train.

As noted earlier, by providing a sufficient amount of energy to Raman amplifier 122, gain saturation can be achieved. This phenomenon is similar to clipping caused in an electrical amplifier that is being driven beyond its operational range. As Raman amplifier 122 receives a surplus of priming energy, the amplification of the peaks of the pulse train results in sharp edged, and flat topped, amplified pulses. The use of gain saturation also has other resulting effects related to signal stability, as will be understood by one of skill in the art. Thus the use of gain saturation is contemplated, but should not be considered as a requirement of the present invention. Amplified pulse train 127 of FIG. 2 illustrates the results of gain saturation being used to restore sharp top edges.

As Raman amplification occurs only when a pulse peak is supplemented by a sufficient amount of energy from pump laser 124, one embodiment of the present invention employs a feedback loop, having as its input the output 136 of the Raman amplifier 122. This feedback loop is employed to assist in synchronising the phase of the pump laser pulsed square wave to the phase of the received pulse train. The implementation of the phase synchronising feedback loop will be well understood by one of skill in the art.

In an alternate embodiment, feedback from the output of the Raman amplifier, and an analysis of the received pulse train, or a combination of the two, can be implemented to control the amplitude of the output of pump laser 124. This control can be used to ensure that Raman amplification is occurring, that gain saturation is achieved, that an unnecessary amount of energy is not being expended, or any combination of these objectives. Once again, the implementation of this amplitude control will be well understood by one of skill in the art.

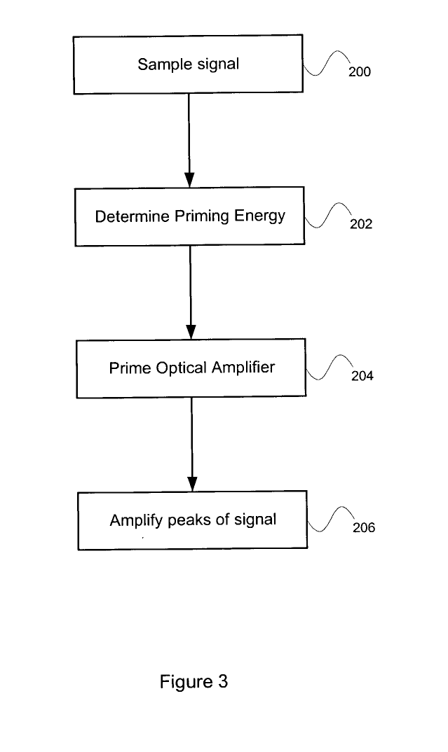

FIG. 3 illustrates a method of the present invention to selectively amplify a pulse train to achieve edge regeneration. Prior to entering the optical amplifier, the pulse train is sampled, and the samples of the pulse train are received by the optical edge regeneration system in step 200. The optical edge regeneration system then, at step 202, determines the optical priming energy required to amplify the pulse train peaks, but not amplify the non-peak portions of the signal. The optical amplifier is then provided with the determined priming energy, at step 204, and the pulse train is amplified, in step 206, by the primed optical amplifier. This method as described above is implemented by the system of FIG. 1. This method can be used to selectively amplify the input with any amplifier that has a distinct turn-on level, such as a Raman amplifier.

The step of determining the required level of priming in step 202 can be done in advance, so that a constant priming level is determined. When a signal is received, only the regions of the pulse train where the peaks and the priming signal are superimposed on each other will have sufficient energy to cause Raman amplification. Non-peak regions, even with the superpositioning of the priming signal, will lack sufficient energy to cause amplification.

In an embodiment of the present invention, the pump laser provides a square wave with a predetermined period and amplitude. This periodic pumped laser is used under the assumption that the received signal will be in phase with the priming signal's square wave. Though such phase synchronisation cannot be guaranteed at all times in large optical networks, it is more easily achieved in smaller networks that are fully planned and managed. Alternately, feedback from the optical amplifier can be used to control the pump laser to achieve phase synchronisation between the square wave pumped laser and the pulse train. One of skill in the art will readily appreciate that the implementation of feedback in this manner is well understood.

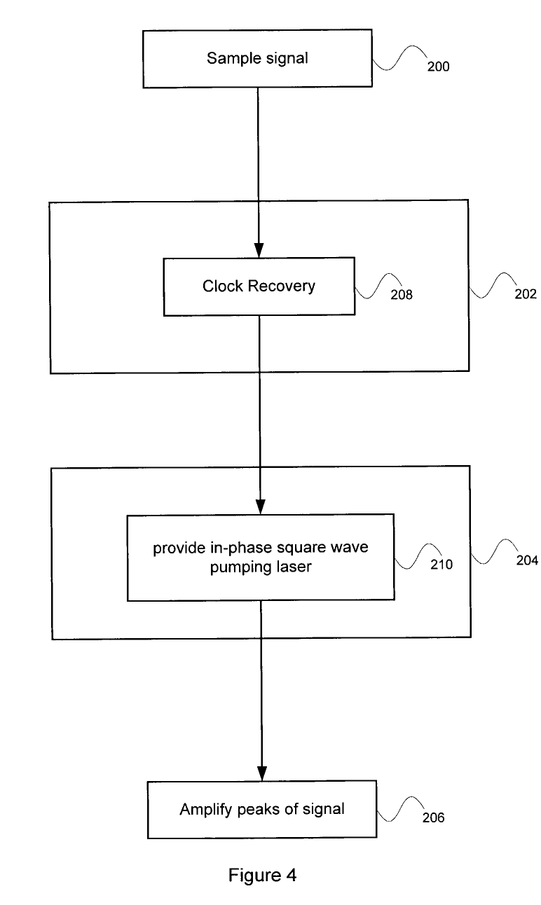

FIG. 4 illustrates an alternate embodiment of the method of FIG. 3. In step 202, the sampled pulse train is analysed to determine its frequency. Clock recovery step 208 determines the frequency of the degraded pulse train. This determined frequency is then used to generate a square wave pumped laser having the same frequency as the pulse train, in step 210, which is a substep of 204. The square wave of the determined frequency is generated by the pump laser and is used to prime the optical amplifier, so that the sections of the pulse train corresponding to the peaks of the square wave are amplified. This provides sharp edges and only amplifies pulse train peaks. If the pulse train and the square wave are not synchronised, feedback control can be optionally applied to achieve synchronisation of the phases. This method can be employed in linear and non-linear amplifiers that have rapid response times that allow them to be actuated in phase with the input signal. SOAs and Raman amplifiers are examples of such amplifiers.

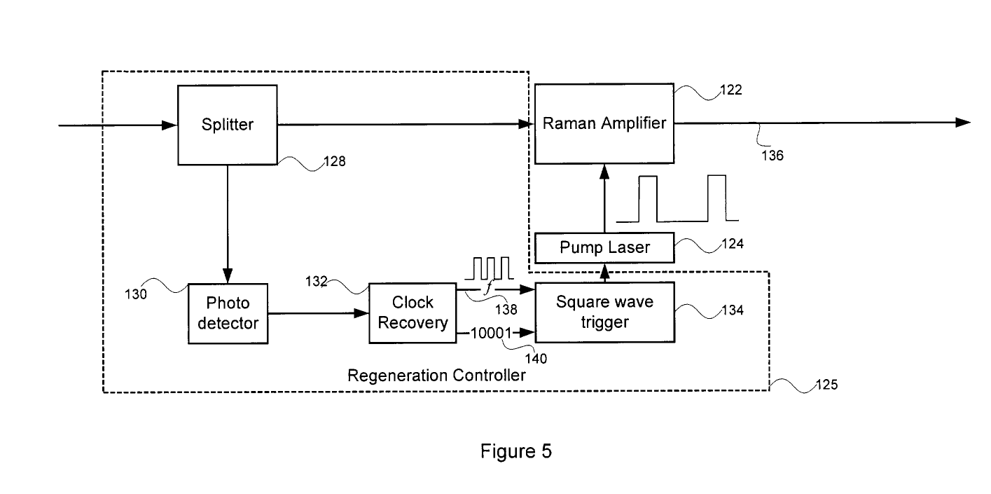

FIG. 5 illustrates a presently preferred embodiment to the present invention. An incoming signal, not illustrated, is a degraded pulse train representing the binary sequence ‘10001’. The incoming signal is provided to both photodetector 130 and Raman amplifier 122 by splitter 128. As in a previous embodiment, photodetector 130 provides an indication to clock recovery unit 132 of the location of the pulses in the incoming signal. Clock recovery unit 132 uses the information provided by photodetector 130 to derive two values. The first value is the frequency of the incoming signal. The second value derived by clock recovery unit 132 is the binary values represented by the incoming signal, which in this case is ‘10001’. Clock recovery unit 132 provides both the frequency 138 and value 140 of the incoming pulse train to square wave trigger unit 134. In another embodiment, clock recovery unit 132 additionally provides square wave trigger unit 134 with the phase of the incoming signal, as discussed above. As before, square wave trigger unit 134 controls pump laser 124 so that the output of pump laser 124 provides sufficient energy so that Raman amplifier 122 will amplify only the peaks of the incoming signal. Because in this embodiment additional processing must occur after photodetector 130, it may be necessary to delay the incoming signal between splitter 128 and Raman amplifier 122, one of skill in the art will readily appreciate a number of ways in which this can be performed. Raman amplifier 122 using the output of pump laser 124 provides, as its output, a reshaped signal. The reshaped signal provides peaks at the regions corresponding to the logical ‘1’ values, and provides no amplification to the regions corresponding to logical ‘0’ values. As a result, the reshaped output signal will appear to a receiver as a square wave representing the binary sequence ‘10001’. This detection of the location of the pulses corresponding to the logical ‘1’ values is commonly referred to as pulse discrimination, and could effectively be implemented through the use of an optical pulse discriminator receiving the incoming signal and connected to square wave trigger unit 134. One of skill in the art will readily appreciate that though reference has been made to logical ‘1’ values as the high values of the incoming signal, logical ‘0’ values could be the high values of the incoming signal under a different signalling scheme without departing from the scope of the present invention.

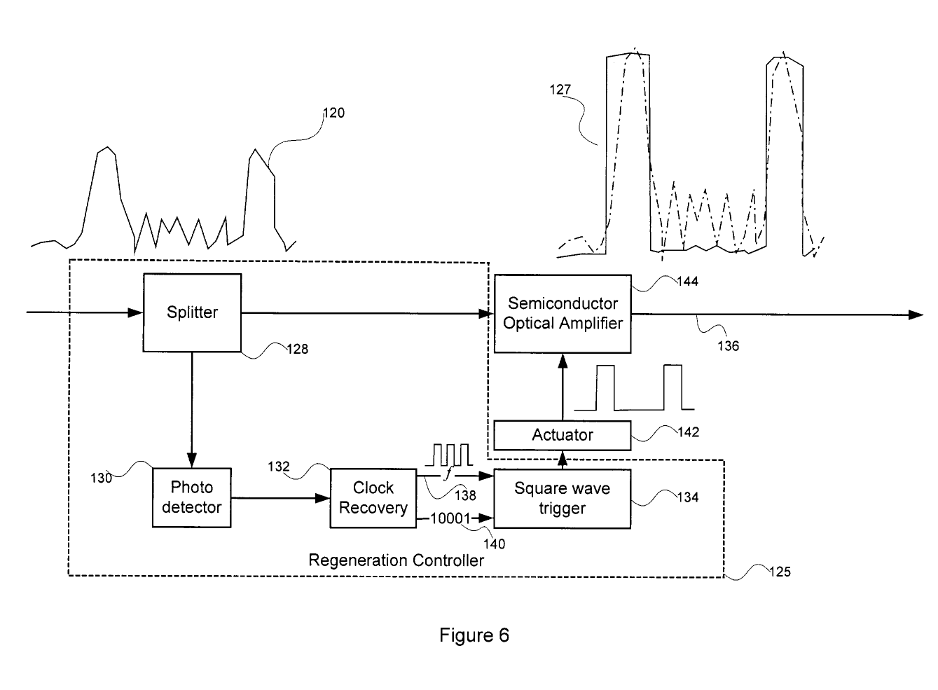

FIG. 6 illustrates the controller of the present invention coupled with a semiconductor optical amplifier (SOA) in place of the Raman amplifier of the previous embodiments. SOAs accept optical signals as input, and are biased by a priming current to amplify the received optical signal. SOAs can be implemented with rapid response times, so that they can be used in conjunction with modulated priming signals. This results in the input signal being reshaped through the selective amplification of the peaks of the signal. FIG. 6 illustrates an embodiment of the present invention, where the input signal 120 is split by splitter 128 and copies are provided to both SOA 144 and photodetector 130. Photodetector 130, and clock recovery unit 132 cooperate to provide the frequency 138 and the phase 140 of the input signal 120 to square wave trigger 134. Square wave trigger 134 controls actuator 142 so that SOA 144 amplifies only the peaks of input 120 to provide an amplified output signal 127 on the output 136 of SOA 144.

The system of the present invention offers the advantage of not requiring that the data-carrying received signal be transformed to an electrical domain representation during edge regeneration. The present invention by being an all optical system does not require that the signal be transferred to the electrical domain. There are many advantages known to those skilled in the art that arise from remaining in the optical domain as much as possible that are realisable through the use of the present system. The system of the present invention also provides a reduction in the number of components required for operation of an edge regeneration system in an optical network. This reduction in the number of components reduces the cost of implementation and provides a system that does not impose as lengthy a time delay as conventional opto-electrical repeaters do. The present system provides optical edge regeneration, without requiring all the added elements of full opto-electrical repeater.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An optical edge reshaping controller for controlling the actuation of an optical amplifier to amplify and reshape the edges of pulses in a pulse train, the controller comprising:
a regeneration controller for controlling the actuation of the optical amplifier by determining at least one priming energy level sufficient to amplify peak regions of the pulse train exceeding a threshold, and insufficient to amplify non-peak regions of the pulse train not exceeding the threshold.

2. The optical edge reshaping controller of claim 1, wherein the regeneration controller includes means for controlling the actuation of a Raman amplifier by controlling a pump laser to provide the at least one priming energy level sufficient to amplify peak regions of the pulse train exceeding a threshold, and insufficient to amplify non-peak regions of the pulse train not exceeding the threshold

3. The optical edge reshaping controller of claim 2, wherein the regeneration controller includes a clock recovery unit for determining the frequency of the pulse train, and for controlling the pump laser to generate a square wave priming signal having the same frequency as the pulse train.

4. The optical edge reshaping controller of claim 3, wherein the clock recovery unit includes means for determining the phase of the pulse train, and for controlling the pump laser such that the generated square wave priming signal has the same phase as the pulse train.

5. The optical edge reshaping controller of claim 3, wherein the regeneration controller includes a photodetector, for sampling the pulse train, and operatively connected to the clock recovery unit to provide the clock recovery unit with an indication of the location of the pulses in the pulse train from which the frequency of the pulse train can be determined.

6. The optical edge reshaping controller of claim 5, wherein the regeneration controller includes a splitter for receiving the pulse train, operatively connected to both the Raman amplifier and the photodetector, for providing both the Raman amplifier and the photodetector with the received pulse train.

7. The optical edge reshaping controller of claim 5, wherein the regeneration controller includes a pulse discriminator for controlling the pump laser to generate a square wave priming signal whose pulses correspond, in frequency and phase, to the pulses in the pulse train.

8. The optical edge reshaping controller of claim 3, wherein the regeneration controller includes a feedback control unit, operatively connected to the Raman amplifier for sampling the amplified pulse train, for synchronising the phase of the generated square wave priming signal to the phase of the pulse train.

9. The optical edge reshaping controller of claim 2, wherein the regeneration controller includes an amplitude control unit for adjusting the amplitude of the priming energy to effect gain saturation in the Raman amplifier.

10. The optical edge reshaping controller of claim 9, wherein the amplitude control unit is operatively connected to the Raman amplifier for sampling the amplified pulse train to determine the required amplitude of the priming energy to effect gain saturation in the amplification of the pulse train.

11. The optical edge reshaping controller of claim 9, wherein the amplitude control unit includes means for sampling the pulse train and determining the required priming energy level to effect gain saturation in the amplification of the pulse train based on the amplitude of the pulses in the pulse train.

12. The optical edge reshaping controller of claim 2, wherein the regeneration controller includes means for controlling the pump laser to generate a square wave priming signal for priming the Raman amplifier.

13. The optical edge reshaping controller of claim 12, wherein the regeneration controller further includes a feedback control unit for sampling the amplified pulse train, and for adjusting the phase of the generated square wave priming signal to synchronise the phase of the generated square wave pumped laser to the phase of the pulse train.

14. The optical edge reshaping controller of claim 13, wherein the feedback control unit includes means for adjusting the frequency of the generated square wave priming signal to synchronise the frequency of the generated square wave pumped laser to the frequency of the pulse train.

15. The optical edge reshaping controller of claim 1, wherein the regeneration controller further includes a clock recovery unit for determining the frequency of the pulse train and for controlling an actuator to generate a square wave priming signal having the same frequency as the pulse train for actuating a semiconductor optical amplifier.

16. A method of reshaping the edges of an optical pulse in a pulse train comprising:
determining at least one priming energy level for an optical amplifier, sufficient to amplify peak regions of the pulse train exceeding a threshold, and insufficient to amplify non-peak regions of the pulse train;
controlling actuation of the optical amplifier in accordance with the determined priming energy level; and
feeding the pulse train to the primed optical amplifier to amplify regions of the pulse train exceeding the threshold.

17. The method of claim 16, wherein:
the step of determining includes determining the priming energy level sufficient to amplify peak regions of the pulse train exceeding the amplification threshold of a Raman amplifier, and insufficient to amplify non-peak regions of the pulse train;
the step of controlling includes controlling the priming of the Raman amplifier in accordance with the determined priming level; and
the step of feeding the pulse train includes the step of feeding the pulse train to the primed Raman amplifier.

18. The method of claim 17, wherein the step of determining includes performing a clock recovery operation on the pulse train to determine the frequency of the pulse train.

19. The method of claim 17, wherein the step of determining includes performing a clock recovery operation on the pulse train to determine the phase of the pulse train.

20. The method of claim 18, wherein the step of controlling the Raman amplifier includes:
generating a square wave having an amplitude equal to the determined priming energy level at the determined frequency; and
providing the generated square wave to the Raman amplifier.

21. The method of claim 20, further including the step of sampling the amplified pulse train at an output of the Raman amplifier and adjusting the phase of the generated square wave to synchronise its phase to the phase of the pulse train.

22. The method of claim 17, further including the step of sampling the amplified pulse train at an output of the Raman amplifier and adjusting the priming energy level to effect gain saturation in the step of amplifying.

23. The method of claim 16, wherein:
the step of determining includes performing a clock recovery operation on the pulse train to determine at least one of the phase and frequency of the pulse train; and
the step of controlling includes controlling the actuation of a semiconductor optical amplifier by controlling an actuator to provide a square wave actuation signal having either determined frequency or phase.

24. An optical edge reshaper for reshaping the edges of pulses in a pulse train, the reshaper comprising:
an optical amplifier for receiving and amplifying the pulse train;
an actuator for providing priming energy to the optical amplifier; and
a regeneration controller for controlling the actuator by determining at least one priming energy level sufficient to amplify peak regions of the pulse train exceeding a threshold, and insufficient to amplify non-peak regions of the pulse train.

25. The optical edge reshaper of claim 24, wherein the optical amplifier is a Raman amplifier and the actuator is a pump laser.

26. The optical edge reshaper of claim 24, wherein the optical amplifier is a semiconductor optical amplifier.
